(19) United States
(12) Patent Application Publication
(10) Pub. No.: US 2020/0264720 A1
(43) Pub. Date: Aug. 20, 2020

(54) TOUCH DISPLAY DEVICE, INTELLIGENT DEVICE, AND DRIVING METHOD

(71) Applicant: HON HAI PRECISION INDUSTRY CO., LTD., New Taipei (TW)

(72) Inventors: REN-YI HUANG, New Taipei (TW); YUAN-HUNG CHIEN, New Taipei (TW)

(21) Appl. No.: 16/523,525

(22) Filed: Jul. 26, 2019

(30) Foreign Application Priority Data
Feb. 20, 2019 (CN) 201910131039.X

(51) Int. Cl. G06F 3/041; G06F 3/044; G09G 3/32

(52) U.S. Cl. CPC G06F 3/0412; G06F 3/0416; G09G 2300/0804; G09G 3/32; G06F 3/044

(57) ABSTRACT

A device having a single electronic structure for touch and display functions comprises a substrate and a plurality of light emitting elements on the substrate. Each light emitting element is located in one sub-pixel unit. A driving circuit on the substrate causes the device to alternate between display periods and touch periods. During each display period, the light emitting elements emit light for image display, and during each touch period, the driving circuit applies touch scan signals to the plurality of light emitting elements and reads self-capacitance value of each light emitting element. A touch position is calculated according to the self-capacitance values of each light emitting element.

### FIELD

The subject matter herein generally relates to human interface devices.

### BACKGR0UND

Tablet computers and smart phones usually have both display and touch functions.

A conventional touch display device having the above functions includes a display module together with a touch module assembled with the display module. While the display module and the touch module cooperate to realize display function and touch function, each module can only perform its own function. However, the above-mentioned conventional touch display device needs both a display module and a touch module, so the touch display device has many integral components. This works against miniaturization, and against devices being less costly. There is room for improvement in the art.

### BRIEF DESCRIPTION OF THE DRAWINGS

Implementations of the present disclosure will now be described, by way of embodiment, with reference to the attached figures.

FIG. 1 is a planar view of a touch display device according to a first embodiment.

FIG. 2 is a planar view of a touch unit and a multiplexer of the device in FIG. 1.

FIG. 3 is a schematic diagram of signal waveforms during operation of the touch display device shown in FIG. 1.

FIG. 4 is a schematic diagram of an circuit equivalent to a light emitting element in the device of FIG. 1.

FIG. 5 is a schematic diagram of a module structure of an intelligent touch display device according to a second embodiment.

FIG. 6 is a flow chart of a method for driving a touch display device.

FIG. 7 is a sub-flow chart of the block S2 of the method in FIG. 6.

### DETAILED DESCRIPTION

It will be appreciated that for simplicity and clarity of illustration, where appropriate, reference numerals have been repeated among different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like.

### Embodiment 1

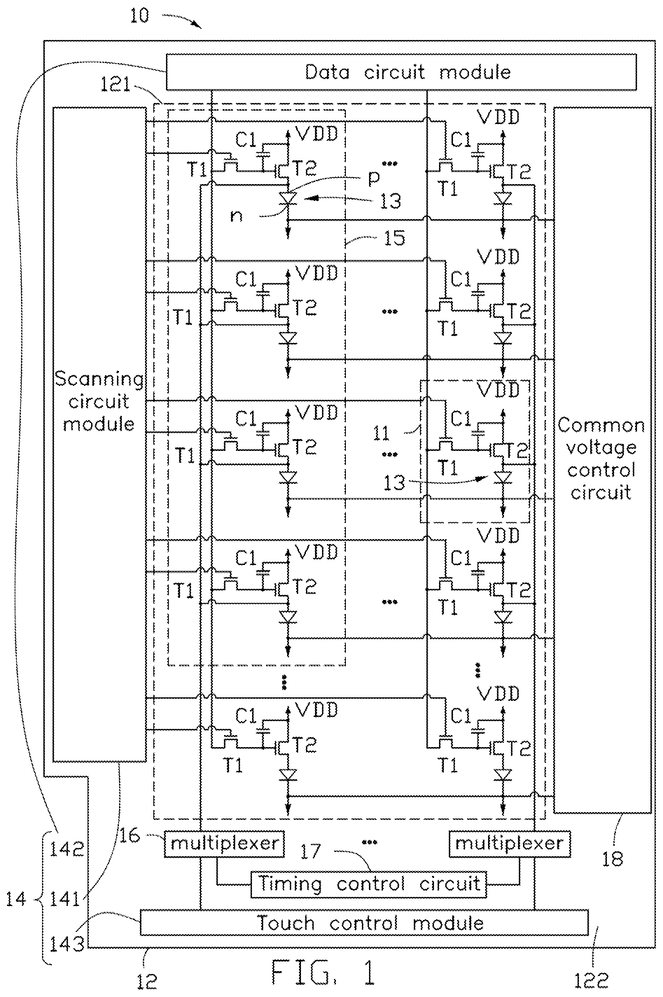

Referring to FIG. 1, the touch display device 10 of the present embodiment defines a display area 121, a non-display area 122 surrounding the display area 121, and a plurality of sub-pixel units 11. All the sub-pixel units 11 are arranged in an array in the display area 121.

The touch display device 10 includes a substrate 12, a plurality of light emitting elements 13, and a driving circuit 14. The light emitting elements 13 and the driving circuit 14 are all located on the substrate 12. The driving circuit 14 includes a scanning circuit module 141, a data circuit module 142, and a touch control module 143.

A portion of the substrate 12 is located in the display area 121, and the other portion of the substrate 12 is located in the non-display area 122. All of the light emitting elements 13 are arranged in an array in the display area 121 of the substrate 12. Each of the sub-pixel units 11 is provided with one light emitting element 13. In the present embodiment, the light emitting elements 13 are Micro Light Emitting Diodes (μLEDs, also known as Micro-LEDs) or Mini Light Emitting Diodes (Mini LEDs). The μLEDs refers to LEDs having size of less than 100 microns, and the Mini LEDs refers to LEDs having size of about 100 microns or more, between the size of conventional LEDs and the size of Micro LEDs.

The driving circuit 14 is located in the non-display area 122 of the substrate 12. The touch display device 10 operates in display periods and touch periods, each display period alternating with one touch period. During each display period, the driving circuit 14 drives the light emitting elements 13 to emit light for image display. During each touch period, the driving circuit 14 applies touch scan signals to the light emitting elements 13 and reads self-capacitance values of each light emitting element 13 for calculating a touch position. A pre-stored algorithm calculates the touch position. A touch operation of a user can be identified according to the touch position to execute an instruction.

It can be understood that several adjacent sub-pixel units 11 constitute one pixel, and the light emitting elements 13 in the sub-pixel units 11 constituting one pixel can emit light of different colors. In the present embodiment, three sub-pixel units 11 constitute one pixel, and the three light emitting elements 13 located in the three sub-pixel units 11 emit red light, green light, and blue light, respectively.

Referring to FIG. 1, the touch display device 10 defines a plurality of touch units 15, each of the plurality of touch units 15 includes at least one light emitting element 13. During each touch period, the driving circuit 14 acquires sum of the self-capacitance change values of all the light emitting elements 13 in each touch unit 15. In an embodiment of the present disclosure, the number of the light emitting elements 13 in each of the touch units 15 is equal, and the number of the light emitting elements 13 in each of the touch units 15 is determined according to the touch sensitivity of the touch display device 10. The higher the sensitivity, the smaller is the number of light emitting elements 13 in each touch unit 15. In the present embodiment, four light emitting elements 13 are located in each touch unit 15.

In the present embodiment, the touch display device 10 further includes a plurality of multiplexers 16 located on the substrate 12. The multiplexers 16 are connected one-to-one to the touch units 15 in a one-to-one manner.

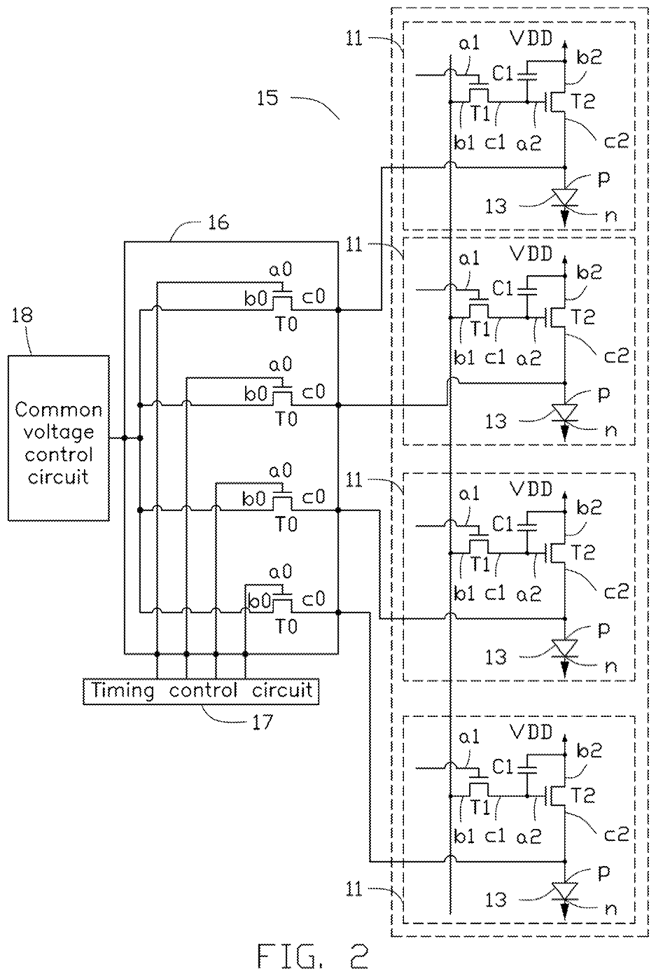

Referring to FIG. 1 and FIG. 2, each of the plurality of multiplexers 16 includes at least one switch T0. The number of switches T0 in each multiplexer 16 is the same as number of the light emitting elements 13 in same touch unit 15 connected to the multiplexer 16. The switch T0 is electrically connected to light emitting elements 13 in a one-to-one manner. In the present embodiment, each touch unit 15 includes four light emitting elements 13, and each multiplexer 16 includes four switches T0. In the present embodiment, the at least one switch T0 is a triode having a control terminal a0, a first terminal b0, and a second terminal c0. Each light emitting element 13 includes an anode and a cathode. Each switch T0 is electrically connected to the anode of one light emitting element 13 through the second terminal c0.

The touch display device 10 further includes a timing control circuit 17 and a common voltage control circuit 18. The control terminal a0 of each switch T0 is electrically connected to the timing control circuit 17, and the timing control circuit 17 outputs a clock signal to control conduction and disconnection between the first terminal b0 and the second terminal c0 of the switch T0. The first terminal b0 of each switch T0 is connected to the touch control module 143 for receiving a touch scan signal Vsense outputted by the touch control module 143. The second terminal c0 of the switch T0 is connected to anode p of the light emitting element 13. The common voltage control circuit 18 is connected to cathode n of one light emitting element 13 for outputting a common voltage Vcom to the cathode n of the light emitting element 13.

The touch display device 10 further includes a plurality of first transistors T1 and a plurality of second transistors T2. One first transistor T1 and one second transistor T2 are located in each sub-pixel unit 11. Each of the plurality of first transistors T1 includes a first control terminal a1, a first connection terminal b1 and a second connection terminal c1, and each of the plurality of second transistors T2 includes a second control terminal a2, a first connection terminal b2, and a second connection terminal c2. In one sub-pixel unit 11, the second connection terminal c1 of the first transistor T1 is connected to the second control terminal a2 of the second transistor T2, and the second connection terminal c1 of the first transistor T1 is connected to the first connection terminal b2 of the second transistor T2. A charging capacitor C1 is connected between the second connection terminal c1 of the first transistor T1 and the first connection terminal b2 of the second transistor T2. In the present embodiment, the plurality of first transistors T1 and the plurality of second transistors T2 are thin film transistors.

Referring to FIG. 1, the scan circuit module 141 is connected to the first control terminal a1 of each first transistor T1 for outputting a gate scan signal Vgate to the first control terminal a1 of each first transistors T1. The data circuit module 142 is connected to the first connection terminal b1 of each first transistor T1 for outputting a data signal Vdata to the first connection terminal b1 of each first transistor T1, the second connection terminal c2 of each second transistors T2 is connected to the anode p of a light emitting element 13.

During each display period, the plurality of first transistors T1 and the plurality of second transistors T2 are used to collectively drive the plurality of light emitting elements 13 to emit light for image display. During each touch period, the light emitting elements 13 do not emit light.

The following describes the operating process of the touch display device 10 provided by the present embodiment:

The touch display device 10 operates in a plurality of display periods and a plurality of touch periods, and each display period alternates with one touch period. One display period and one touch period adjacent constitute an operating cycle, and operation of the touch display device 10 is basically the same in each operating cycle. Operation of each sub-pixel unit 11 is basically the same, so the operation of one sub-pixel unit 11 in one operating cycle will be exemplified below.

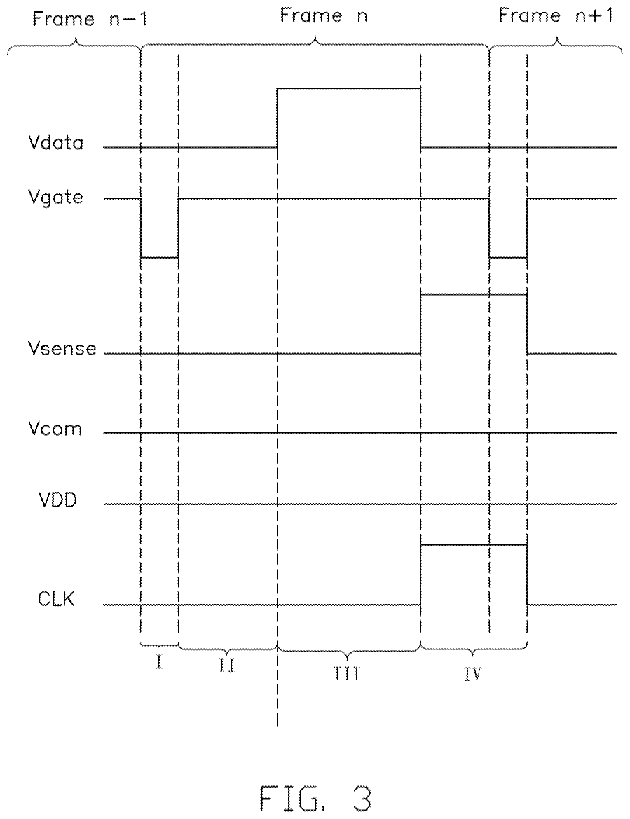

Referring to FIG. 2 and FIG. 3, frame n−1 has been displayed before period I, and during the period I, reading display data of frame n. During the period I, the gate scan signal Vgate is in a low level, and the data signal Vdata is also in a low level. During period II, the gate scan signal Vgate is in a high level, the first connection terminal b1 and the second connection terminal c1 of the first transistor T1 are in a conduction status, but the data signal Vdata is still in a low level, so the touch display device 10 displays a black screen. During period III, the first connection terminal b1 and the second connection terminal c1 of the first transistor T1 remain conductive, the data signal Vdata is in a high level, the first connection terminal b2 and the second connection terminal c2 of the second transistor T2 are conductive, voltage of the anode p of the light emitting element 13 is determined by the data signal Vdata and the voltage of the first connection terminal b2 of the second transistor T2. Voltage of the first connection terminal b2 of the second transistor T2 is the constant VDD. Voltage of the cathode n of the light emitting element 13 is a common voltage Vcom. A voltage difference is formed between the anode p and the cathode n of the light emitting element 13, so the light emitting element 13 emits light. A difference in voltage causes the light emitting element 13 to emit different brightnesses, due to the common voltage Vcom and the voltage of the first terminal b2 of the second transistors T2 set to a constant value, so the brightness of light emitted by the light emitting element 13 is determined by the data signal Vdata. When the first connection terminal b2 and the second connection terminal c2 of the second transistor T2 are conducting, the charging capacitor C1 is being charged. When the data signal Vdata is in a low level, the charging capacitor C1 can keep the light emitting element 13 illuminated for a period of time by discharging, so that the light emitting element 13 will not stop emitting light as soon as the data signal Vdata goes to a low level from a high level. At a same time, light emitting elements 13 of the touch display device 10 emit light of different brightnesses to cooperate to realize image display. One period I, one period II, and one period III continuously are defined as one display period, the touch scan signal Vsense is in a low level throughout the display period, and the timing control circuit 17 outputs a clock signal CLK in a low level.

Referring to FIG. 2 and FIG. 3 together, in period IV, the frame n is completed, the data signal Vdata is in a low level, and the light emitting element 13 stops emitting light, so the touch display device 10 displays the black screen again. The touch scan signal Vsense is in a high level, the timing control circuit 17 outputs the clock signal CLK in a high level, the first connection terminal b0 and the second connection terminal c0 of the switch T0 are conducting, so that the touch scan signal Vsense can be outputted to the anode p of the light emitting element 13. A touch detection signal can be obtained according to the touch scan signal Vsense. A current touch position will be calculated according to a series of operations on the touch detection signal, the current touch position is used to activate a corresponding function of the touch display device 10. The period IV is defined as a touch period, and the touch period can continue until it begins to read the data signal Vdata of next frame (frame n+1).

In each touch unit 15 of the present embodiment, four sub-pixel units 11 are included, that is, the touch unit 15 includes four light emitting elements 13. One touch unit 15 is connected to one multiplexer 16, and one multiplexer 16 includes four switches T0. Each switch T0 is connected to one light emitting element 13, and each switch T0 is connected to the timing control circuit 17. The timing control circuit 17 outputs four clock signals CLK for controlling the four switches T0 in a one-to-one manner. The four clock signals CLK are in a high level in a time division manner. Each of the four clock signals CLK controls one of the four switches T0 to be turned on or off, so that the touch scan signals Vsense are outputted to the light emitting elements 13 in a time division manner. The time division manner, that is, at one time, a touch scan signal Vsense is applied to one light emitting element 13, and at another time, a touch scan signal is applied to another light emitting element.

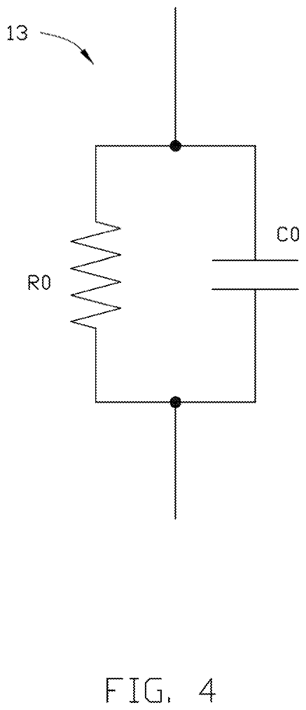

In the present embodiment, the light emitting elements 13 are μLEDs. Referring to FIG. 4, internal structure of a μLED is equivalent to a resistor R0 and a capacitor C0 connected in parallel with each other. The capacitor C0 is a self-capacitance of the μLED, and the above-mentioned touch detection signal is the self-capacitance of the μLED. In the present embodiment, the touch position is calculated according to the sum of the self-capacitance values of all the μLEDs in each touch unit 15.

The touch display device 10 of the present embodiment includes the substrate 12, the plurality of light emitting elements 13, and the driving circuit 14 located on the substrate 12. The touch display device 10 operates in a plurality of display periods and a plurality of touch periods, and each display period alternates with one touch period. During each display period, the driving circuit 14 drives the plurality light emitting elements 13 to emit light to realize image display. During each touch period, the light emitting elements 13 do not emit light, the driving circuit 14 applies the touch scan signals to the plurality of light emitting elements 13 to obtain the self-capacitance value of the plurality of light emitting elements 13 for calculating the touch position and to identify user's touch operation. Therefore, the touch display device 10 provided by the present embodiment of the present invention realizes display function and touch function at the same time without additional structure to support the touch function, thereby saving cost and making the touch display device 10 thinner and lighter.

### Embodiment 2

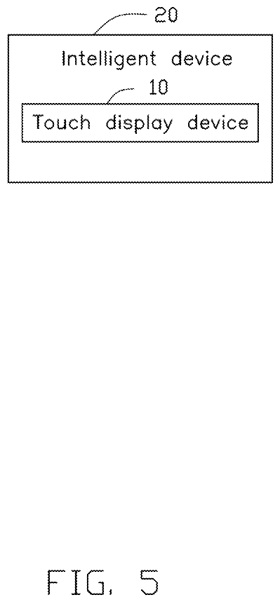

Referring to FIG. 5, an intelligent device 20 provided in the present embodiment is a device that has display function and touch function at the same time, such as a tablet computer, an electronic touch display screen, and the like. The intelligent device 20 includes a touch display device 10, and the touch display device 10 is, for example, as described in the first embodiment.

It should be understood that the intelligent device 20 provided by the present embodiment achieves all the functions described in the first embodiment.

### Embodiment 3

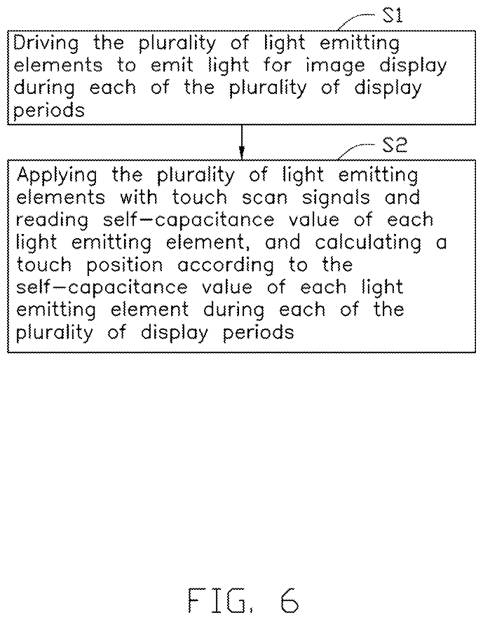

Referring to FIG. 6, a driving method provided in the present embodiment is applied to the touch display device 10 described in the first embodiment. The touch display device 10 includes the plurality of light emitting elements 13. The touch display device 10 operates in the plurality of display periods and a plurality of touch periods, and each display period alternates with one touch period, and the driving method includes:

block S1, driving the plurality of light emitting elements to emit light for image display during each of the plurality of display periods;

block S2, applying the plurality of light emitting elements with touch scan signals and reading self-capacitance value of each light emitting element, and calculating a touch position according to the self-capacitance value of each light emitting element during each of the plurality of display periods.

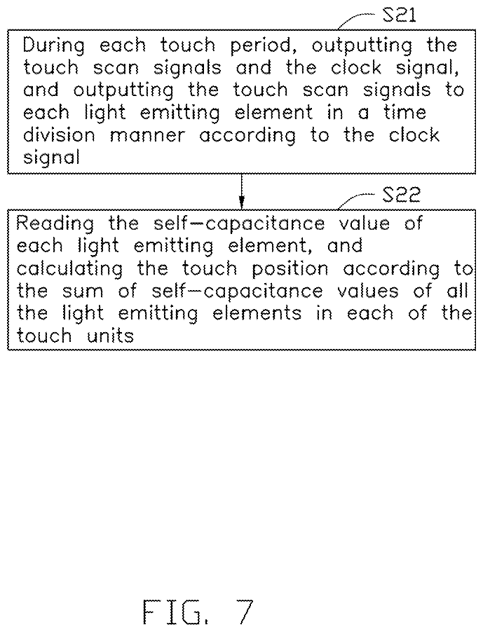

Referring to FIG. 7, block S2 further includes:

block S21, during each touch period, outputting the touch scan signals and the clock signal, and outputting the touch scan signals to each light emitting element in a time division manner according to the clock signal;

block S22, reading the self-capacitance value of each light emitting element, and calculating the touch position according to the sum of self-capacitance values of all the light emitting elements in each of the touch units.

Details of the touch display device can be found in the related description in the first embodiment.

The driving method provided by the present embodiment calculates the touch position by reading the self-capacitance value of each light emitting element to identify the touch operation of a user, so as to realize display function and touch function in the same display device 10 without additional structure to separately support touch function, and save the overall cost of the touch display device 10 and allow the touch display device 10 to be thinner and lighter.

It is to be understood, even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A touch display device defining a plurality of sub-pixel units; the touch display device comprising:
a substrate;
a plurality of light emitting elements on the substrate, each of the plurality of light emitting elements located in one of the plurality of sub-pixel unit; and
a driving circuit on the substrate and electrically connected to the plurality of light emitting elements;
wherein the touch display device operates in a plurality of display periods and a plurality of touch periods, and each display period alternating with one touch period; during each display period, the driving circuit drives the plurality of light emitting elements to emit light for image display, during each touch period, the plurality of light emitting elements do not emit light; the driving circuit applies touch scan signals to the plurality of light emitting elements and reads self-capacitance value of each light emitting element, and a touch position is calculated according to the self-capacitance value of each light emitting element.

2. The touch display device of claim 1, wherein each of the plurality of light emitting elements is a light emitting diode.

3. The touch display device of claim 1, further comprising a plurality of multiplexers; each of the plurality of multiplexers is electrically connected to at least one light emitting element and the driving circuit.

4. The touch display device of claim 3, wherein the at least one of the plurality of light emitting elements is defined as a touch unit, and the touch display device has a plurality of touch units;
the plurality of touch units and the plurality of multiplexers are electrically connected to each other in a one-to-one manner.

5. The touch display device of claim 4, wherein each of the plurality of multiplexers comprises at least one switch, each switch of one of the plurality of the multiplexers is electrically connected to one of the plurality of the light emitting elements in one of the plurality of touch units.

6. The touch display device of claim 5, further comprising:
a timing controlling circuit;
wherein each switch includes
a control terminal electrically connected to the sequence control circuit,
a first terminal electrically connected to one light emitting element, and
a second terminal electrically connected to the driving circuit.

7. The touch display device of claim 5, further comprising a common voltage control circuit;
wherein each of the plurality of the light emitting elements comprises an anode and a cathode; the anode of each of the plurality of the light emitting elements is electrically connected to one switch, and the cathode of each of the plurality of light emitting elements is electrically connected to the common voltage control circuit.

8. The touch display device of claim 4, wherein each of the plurality of touch units comprises a same quantity of light emitting elements.

9. The touch display device of claim 1, further comprising a plurality of first transistors and a plurality of second transistors, the plurality of first transistors and the plurality of second transistors are electrically connected to the plurality of light emitting elements in an one-to-one manner, one first transistor and one second transistor are located in each sub-pixel;
one first transistor and one second transistor are configured to drive one light emitting element electrically connected to the first transistor and the second transistor in the display period.

10. An intelligent device, comprising:
a touch display device defining a plurality of sub-pixel units; the touch display device comprising:
a substrate;
a plurality of light emitting elements on the substrate, each of the plurality of light emitting elements located in one of the plurality of sub-pixel unit; and
a driving circuit on the substrate and electrically connected to the plurality of light emitting elements;
wherein the touch display device operates in a plurality of display periods and a plurality of touch periods, and each display period alternating with one touch period; during each display period, the driving circuit drives the plurality of light emitting elements to emit light for image display, while during each touch period, the plurality of light emitting elements do not emit light, the driving circuit applies touch scan signals to the plurality of light emitting elements and reads self-capacitance value of each light emitting element, and a touch position is calculated according to the self-capacitance value of each light emitting element.

11. The intelligent device of claim 10, wherein the touch display device further comprising a plurality of multiplexers;
each of the plurality of multiplexers is electrically connected to at least one light emitting element and the driving circuit.

12. The intelligent device of claim 11, wherein the touch display device defines a plurality of touch units, each of the plurality of touch units comprises at least one of the plurality of light emitting elements;
the plurality of touch units and the plurality of multiplexers are electrically connected to each other in a one-to-one manner.

13. The intelligent device of claim 12, wherein each of the plurality of multiplexers comprises at least one switch, each switch of a same multiplexer is electrically connected to one of the plurality of the light emitting elements in a same touch unit electrically connected to the multiplexer.

14. The intelligent device of claim 13, wherein the touch display device further comprising a timing controlling circuit;
a control terminal of each switch is electrically connected to the sequence control circuit, a first terminal of each switch is electrically connected to one light emitting element, and a second terminal of each switch is electrically connected to the driving circuit.

15. The intelligent device of claim 13, wherein the touch display device further comprising a common voltage control circuit;
each light emitting element comprises an anode and a cathode;
the anode of each light emitting element is electrically connected to one switch, and the cathode of each light emitting element is electrically connected to the common voltage control circuit.

16. A driving method of a touch display device, wherein the touch display device comprises a plurality of light emitting elements, and operates in a plurality of display periods and a plurality of touch periods, each display period alternates with one touch period, the driving method comprising:
driving the plurality of light emitting elements to emit light for image display during each of the plurality of display periods;
applying the plurality of light emitting elements with touch scan signals, reading self-capacitance value of each light emitting element, and calculating a touch position according to the self-capacitance value of each light emitting element during each of the plurality of display periods.

17. The driving method of claim 16, wherein the touch display device defines a plurality of touch units, each of the plurality of touch units comprises at least one light emitting element;
wherein when applying the plurality of light emitting elements with touch scan signals, reading self-capacitance value of each light emitting element, and calculating a touch position according to the self-capacitance value of each light emitting element during each of the plurality of display periods, further comprising:
applying the plurality of light emitting elements with a touch scan signal and reading self-capacitance value of each light emitting element, and calculating a touch position according to a sum of the self-capacitance value of all the light emitting elements in each of the touch units.

18. The driving method of claim 17, wherein when applying the plurality of light emitting elements with a touch scan signal, further comprises:
outputting the touch scan signals and a clock signal, and outputting the touch scan signals to each light emitting element in a time division manner according to the clock signal.
